(19) United States
(12) Patent Application Publication
(10) Pub. No.: US 2023/0211848 A1
(43) Pub. Date: Jul. 6, 2023

(54) CARGO TRICYCLE

(71) Applicant: Boseco, Inc., San Jose, CA (US)

(72) Inventors: Kostyantyn YUN, Odesa (UA); Oleksandr KUZMIN, Odesa (UA)

(21) Appl. No.: 17/684,203

(22) Filed: Mar. 1, 2022

(30) Foreign Application Priority Data
Dec. 31, 2021 (UA) A202107834

(51) Int. Cl. B62K 5/05; B62J 7/06; B62J 9/10

(52) U.S. Cl. CPC B62K 5/05; B62J 7/06; B62J 9/10

(57) ABSTRACT

A tricycle for transportation of cargoes, comprising a frame on which connecting rods with pedals are mounted, a steering wheel, at least one driving sprocket, which is connected with the front axle by a flexible chain element, a bottom bracket shell, a seat; the front load-carrying platform with the front axle is rigidly fixed to the frame. The front axle of the cargo tricycle connected to the front load-carrying platform by external bearings has two front wheels, which are rigidly fixed onto two half-axles inserted into the external bearings connected by freewheeling clutches, between which a driven sprocket is located. The frame has a connected swivel fork, in which the rear wheel is mounted and which, via a swing rod assembly, is connected to the steering wheel.

In some cases, the tricycle may be equipped with one or two electric motors.

### FIELD OF THE INVENTION

This invention belongs to the category of vehicles, in particular, to bicycles for transportation of cargoes and passengers.

### BACKGROUND OF THE INVENTION

From the background of invention, we know bicycles for transportation of cargoes and passengers.

Cargo bicycles having a frame with a steering wheel, a seat, connecting rods with pedals and flexible chain element, a front driving wheel and a load-carrying platform with two wheels located behind the seat are widely known.

The drawback of these vehicles is the rear location of the load-carrying platform. Due to the fact that the rear wheels should bear the weight of the driver, the payload capacity of such vehicle is reduced. Moreover, the inability to visually monitor the condition of the cargo on the load-carrying platform makes it insufficiently convenient and safe to transport people and any cargoes.

There is a bicycle for transportation of passengers, comprising a frame with a seat and a rear wheel, a trailer with two front wheels pivotally connected to the frame (Ukrainian Utility Model Patent No. 7323 “BICYCLE FOR TRANSPORTATION OF PASSENGERS”, B62K7/00, published on Jun. 15, 2005).

The drawback of this vehicle is the control circuit, i.e., the front wheels are steerable, which is provided by a pivot connection between the frame and the trailer, so to make a turn, it is necessary to make considerable effort to turn the trailer, and the greater the weight of the load, the greater the effort, which limits the load capacity of the bicycle.

The known utility model which has been chosen as the closest prior art, includes a frame to which the seat is attached, a rear wheel with a bushing and at least one driven sprocket which is connected by a flexible chain element with at least one driving sprocket mounted on one of the two connecting rods with pedals, in addition, it contains a bottom bracket shell connected by a hollow tube to a swivel block located under the front load-carrying platform having two front wheels and a steering wheel mounted on it (Ukrainian Utility Model Patent No. 136040 “CARGO TRICYCLE”, B62K7/04, published on Jul. 25, 2019).

The drawback of this vehicle is the difficulty of its driving, as the front wheels bearing the weight of the load are steerable, so in order to make a turn, the driver should move the wheels of the front load-carrying platform in a direction perpendicular to the direction of the tricycle, consequently, the greater the weight of the load, the greater effort should be applied to make a turn, which limits the load capacity, and besides, the fixture of the front wheels does not provide proper road grip during turning and maneuvering.

### SUMMARY OF THE INVENTION

The purpose of this invention was to improve the cargo tricycle, i.e., by changing the design of the front axle connecting the front wheels, as well as the control circuit of the cargo tricycle, to increase the load capacity, to improve the maneuverability and the road grip, making it more comfortable and safe for transportation of any cargoes and passengers.

The above mentioned task has been solved as follows: the cargo tricycle comprises a frame on which two connecting rods with pedals are mounted, one of which having at least one driving sprocket, a bottom bracket shell, a seat, a rear wheel, a front load-carrying platform with two front wheels, a steering wheel, a swivel block, a driven sprocket connected with the driving sprocket by a flexible chain element, characterized in that the rear wheel is mounted in a swivel fork, which is connected, by a swivel block, to the steering wheel located on the frame, the front load-carrying platform is combined with the frame, the front wheels are fixed rigidly on two half-axles connected by freewheeling clutches with the driven sprocket between them, which are installed into external bearings attached to the front load-carrying platform.

Moreover, the seat is located above the rear wheel.

Besides, the steering wheel is equipped with brake handles with brake rods connected with disc brakes which are installed on the front wheels.

In addition, the rear wheel is equipped with an electric motor.

And the bottom bracket shell is equipped with an electric motor.

The change of the cargo tricycle’s the control circuit by using a swivel fork to attach the rear wheel, which is connected, via a swivel block, to the steering wheel located on the frame, makes the rear wheel steerable, and thus the turning force becomes virtually independent of the weight of the load. This allows to drive the cargo tricycle without excessive effort, it makes it more maneuverable and easy to use and does not limit its load capacity to the muscular force of the driver.

The design of the front load-carrying platform united to the frame ensures the integrity of the structure, which allows to increase the payload capacity of the platform and to apply the drive to the front wheels.

The design of the cargo tricycle’s front axle, namely, the front wheels fixed rigidly on two half-axles, the half-axles mounted on the external bearings, which are attached to the front load-carrying platform and connected by freewheeling clutches with one driven sprocket between them, allows to use a simple drive on the front wheels.

The use in the design of one driven sprocket together with the freewheeling clutches on the half-axles ensures the torque transmission from one driven sprocket to both front wheels, which ensures a stable straight line movement of the cargo tricycle. With that, the presence of the freewheeling clutches allows the wheels to rotate at different speeds, which provides a secure road grip when turning, an independent coming out of corners, it significantly reduces the possibility of skidding and thus improves the maneuverability and controllability of the cargo tricycle, and consequently, the safety of transportation of cargoes and passengers.

The location of the seat above the rear wheel allows to lessen the load of the cargo tricycle’s front wheels from the driver’s weight, which increases the load capacity even more.

Installation of the disc brakes on the front wheels allows to increase the maneuverability of the cargo tricycle, which increases the safety of transportation of cargoes and people even more.

Equipping the rear wheel with an electric motor allows the simultaneous use of the chain drive on the front wheels and of the electric drive on the rear wheel, which makes the cargo tricycle all-wheel drive and thus increases the controllability and maneuverability of the cargo tricycle even more. This allows to use the cargo tricycle in almost any weather conditions (on slippery roads: after rain or snow) and increases the passability on difficult terrain (upslope, moving on sand or gravel).

Equipping the bottom bracket shell with an electric motor increases the cargo tricycle’s power even more, which allows to increase the load capacity, as well as the speed of movement.

The possibility of equipping the bottom bracket shell with an electric motor and the presence of an electric motor on the rear wheel allows to further increase the load capacity, speed and maneuverability of the cargo tricycle.

### BRIEF DESCRIPTION OF THE DRAWINGS

The invention is illustrated by the drawings.

FIG. 1 shows a side view of the cargo tricycle.

FIG. 2 shows a top view of the cargo tricycle.

FIG. 3 shows a general view of the front axle of the cargo tricycle.

FIG. 4 shows the front axle in sectional view.

FIG. 5 shows a side view of the cargo tricycle with electric motors.

Neither the cargo tricycle’s drawings, nor the description of the design or of the use limit in any way the scope of the claims set forth in the patent claim, they only explain the essence of the invention.

### DESCRIPTION OF PREFERRED EMBODIMENTS

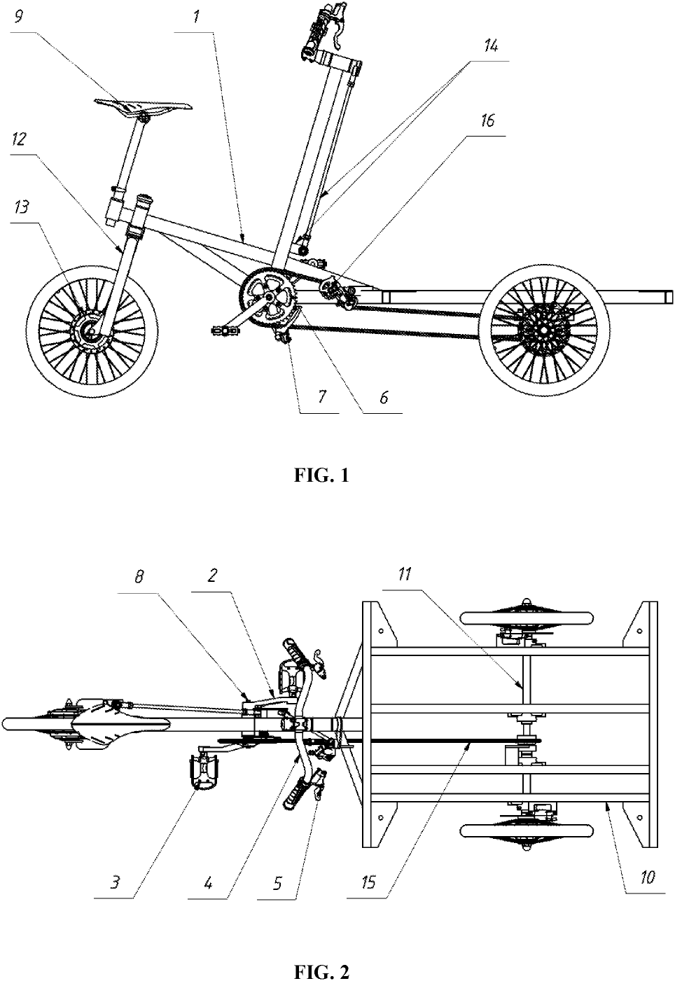

The cargo tricycle (FIGS. 1 and 2) consists of a frame (1), on which connecting rods (2) with pedals (3) are mounted, a steering wheel (4), brake handles (5), at least one driving sprocket (6), in some cases, if there are several driving sprockets, the frame is equipped with a speed switch (7), a bottom bracket shell (8), a seat (9) and a front load-carrying platform (10) with a front axle (11) and mounting holes (not marked on FIGS. 1 and 2), rigidly fixed to the frame (1).The frame (1) has a connected swivel fork (12), in which the rear wheel is mounted (13) and which, via a swing rod assembly (14), comprising pull rods and levers, is connected to the steering wheel (4). The driving sprocket (6) is connected to the front axle (11) by a flexible chain element (15), which is equipped with a chain tensioner (16).

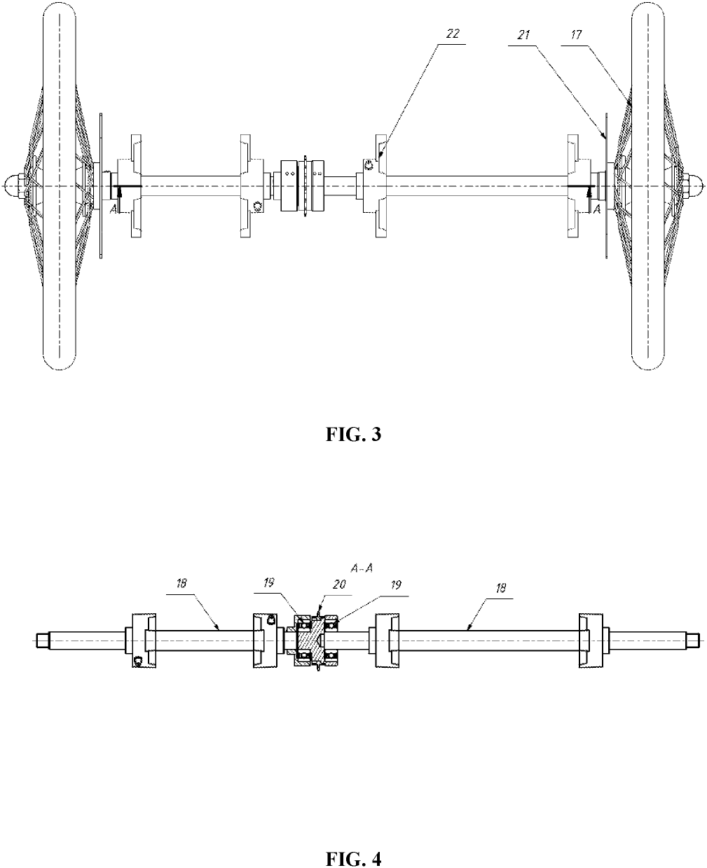

The cargo tricycle’s front axle (11) (FIGS. 3 and 4) has two front wheels (17), which are fixed rigidly on two half-axles (18) connected by freewheeling clutches (19), between which a driven sprocket (20) is located. In some cases, the front wheels (17) may be equipped with discs brakes (21). The front axle (11) is connected to the front load-carrying platform (10) by external bearings (22), in which the half-axles (18) are installed.

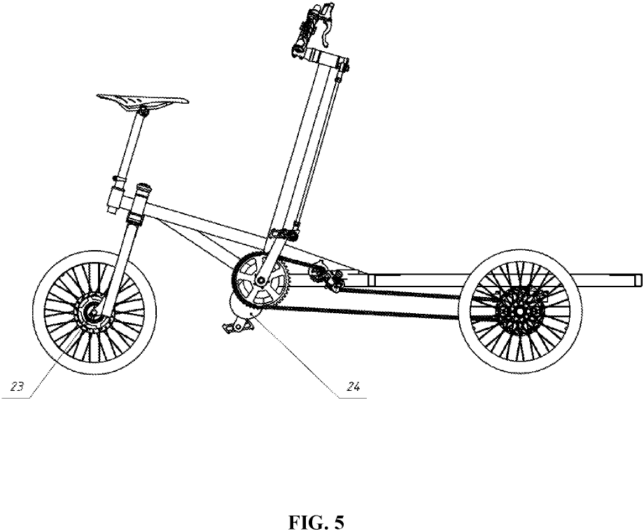

In some cases, the rear wheel (13) may be equipped (FIG. 5) with an electric motor (23), well known from the background of invention as a motorized wheel. In some cases, the bottom bracket shell (8) may be equipped with an electric motor (24), well known from the background of invention as an electric motor with a battery and a microcontroller. In some cases, the tricycle can be made with two electric motors (23 and 24).

The cargo tricycle should be used as follows.

To put the cargo tricycle in motion, the driver should sit down on the seat (9) and apply force to the pedals (3), thereby rotating the connecting rods (2), which, in turn, will transmit the force to the rotating driving sprocket (6). The driving sprocket (6) is connected by a flexible chain element (15) to the driven sprocket (20), thus transmitting the torque to the front axle (11). In turn, the driven sprocket (20) transmits the torque to the front wheels (17), which begin to rotate and the tricycle starts moving. In case the rear wheel (13) is equipped with an electric motor (23), the driver can, if needed, simultaneously turn on the electric motor (23) and, thus, make the cargo tricycle all-wheel drive.

If the cargo tricycle’s bottom bracket shell (8) is equipped with an electric motor (24), it allows the driver to turn on the electric motor (24) if needed and to transport the cargo both with and without the use of the driver’s muscular force.

To make a turn, the driver should rotate the steering wheel (4), which is connected via a swivel block (14) to the swivel fork (12), and should turn the rear wheel (13) in the direction of movement.

The described cargo tricycle is characterized by simple design and small size, while ensuring high maneuverability and maximum payload capacity of the front load-carrying platform, which can be connected to a box with a coffee machine, a refrigerator with ice cream, a trailer for transportation of cargoes, a mail van, a trailer for transportation of passengers, which makes it more convenient and safe for both cargo and passengers transportation.

The possibility of simultaneous use of the chain drive on the front wheels and the electric drive on the rear wheel makes this cargo tricycle all-wheel drive, which further improves the performance of this cargo vehicle, its maneuverability and safety, and the use of the bottom bracket shell with an electric motor can increase the power of the cargo tricycle, and hence its load capacity.

1. A cargo tricycle, comprising: a frame on which two connecting rods with pedals are mounted, one of which having at least one driving sprocket, a bottom bracket shell, a seat, a rear wheel, a front load-carrying platform with two front wheels, a steering wheel, a swivel block, a driven sprocket connected with the driving sprocket by a flexible chain element, characterized in that the rear wheel is mounted in a swivel fork, which is connected, by the swivel block, to the steering wheel located on the frame, the front load-carrying platform is combined with the frame, the front wheels are fixed rigidly on two half-axles connected by freewheeling clutches with the driven sprocket between them, which are installed into external bearings attached to the front load-carrying platform.

2. A cargo tricycle as defined in claim 1, characterized in that the seat is located above the rear wheel.

3. A cargo tricycle as defined in claim 1 characterized in that the steering wheel is equipped with brake handles with brake rods connected with disc brakes which are installed on the front wheels.

4. A cargo tricycle as defined in claim 1 characterized in that the rear wheel is equipped with an electric motor.

5. A cargo tricycle as defined in claim 1 characterized in that the bottom bracket shell is equipped with an electric motor.
